(19) United States
(12) Patent Application Publication
(10) Pub. No.: US 2022/0198180 A1
(43) Pub. Date: Jun. 23, 2022

(54) GESTURE ANALYSIS FOR AUTONOMOUS VEHICLES

(71) Applicant: GM Cruise Holdings LLC, San Francisco, CA (US)

(72) Inventor: Casey Weaver, San Francisco, CA (US)

(21) Appl. No.: 17/132,061

(22) Filed: Dec. 23, 2020

(51) Int. Cl. G06K 9/00; G06F 3/01; G06N 3/08; G05D 1/02

(52) U.S. Cl. CPC G06K 9/00355; G06F 3/017; G05D 1/0257; G05D 1/0221; G05D 1/0231; G06N 3/08

(57) ABSTRACT

The disclosed technology provides solutions for automating the interpretation of traffic hand signals, for example, in an autonomous vehicle (AV) deployment. A process of the disclosed technology can include steps for aggregating a plurality of three-dimensional (3D) gesture sequences, processing each of the gesture sequences to generate two-dimensional gesture data, and training a machine-learning (ML) model using at least a portion of the plurality of two-dimensional gesture images for each of the 3D gesture sequences to generate a trained ML model. Systems and machine-readable media are also provided.

### BACKGROUND

### 1. Technical Field

The subject technology relates to solutions for interpreting hand signals and in particular, for helping autonomous vehicles (AVs) decode traffic hand signals to inform vehicle routing and maneuver decisions.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as avoiding dangerous or difficult routes, interpreting pedestrian and driver hand signals, and performing other navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a block diagram of an example system for identifying gestures, such as traffic hand signals, according to some aspects of the disclosed technology.

FIG. 2A illustrates a block diagram of an example system for generating or training a gesture classification model, according to some aspects of the disclosed technology.

FIG. 2B illustrates a block diagram of an example system for implementing traffic hand gesture identification, for example, on an autonomous vehicle (AV) according to some aspects of the disclosed technology.

FIG. 3 illustrates a block diagram of a process for performing traffic signal gesture identification, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Human drivers of conventional (non-autonomous) vehicles routinely interpret hand gestures (e.g., traffic hand signals) from various traffic participants, such as, pedestrians, bicyclists, motorcyclists, and other drivers, etc. However, in autonomous vehicle (AV) deployments, such as those used in a ride sharing fleet, AVs would benefit from the ability to interpret gestures, such as traffic hand gestures, to better comprehend the behavior of nearby pedestrians and vehicles.

Aspects of the disclosed technology addresses the foregoing need by providing systems and methods for interpreting gestures made by pedestrians and various traffic participants. In some aspects, the disclosed technology includes methods for identifying the relevance of a particular gesture, e.g., to determine if the observed gesture is relevant to the observing vehicle. Additionally, observed gestures can be evaluated to determine likely future behaviors of the issuing participant, e.g., turns, slowing, stopping, etc.

A gesture interpretation/identification system of the disclosed technology can utilize one or more machine-learning (ML) models that are configured to perform gesture classification/identification. Identified gestures can then be used to inform AV maneuvering and navigation operations. As discussed in further detail below, ML models used to perform gesture identification may be trained using two-dimensional image input files that are extracted from three-dimensional video (motion) files, for example, of traffic gestures.

As used herein, a signal (or gesture, hand signal, traffic hand signal/gesture), can refer to any physical movement that is used communicate an intended behavior between pedestrians and/or vehicles. By way of example, traffic hand signals can include various traffic signifiers (e.g., left turn, right turn, slow down, and/or stop), as defined by the U.S. Department of Transportation National Highway Traffic Safety Administration. However, it is understood that the disclosed technology is not limited to a particular set of signals or gestures; rather, the disclosed technology may be generalized for use in interpreting or identifying virtually any type of signals or gestures. Therefore, the examples provided herein are intended to illustrate some applications in which the disclosed technology can be implemented, but is not intended as an exhaustive description of such use cases.

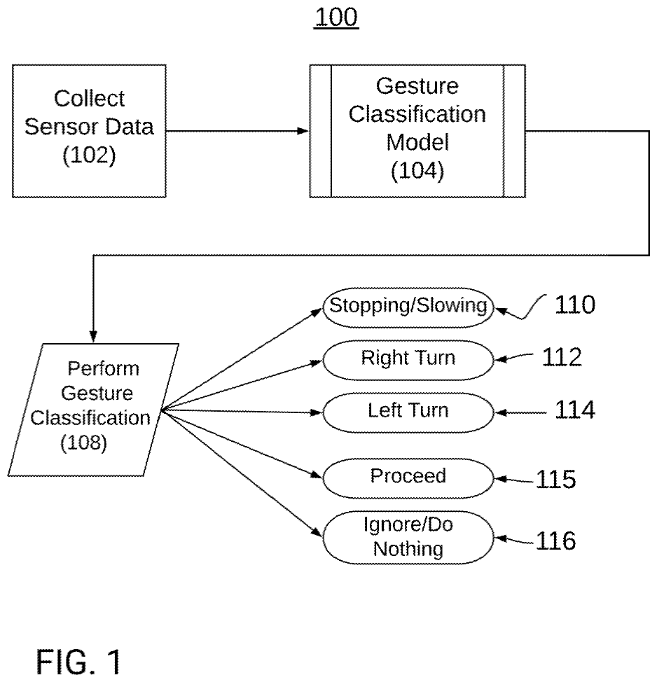

FIG. 1 illustrates a block diagram of an example system 100 for identifying and classifying gestures, such as traffic hand signals. System 100 includes a data collection process (102), in which sensor data is collected, e.g., for a surrounding environment, such as an area surrounding an autonomous vehicle (AV). As used herein, sensor data can include any data collected by various AV sensors, such as, cameras, Light Detection and Ranging (LiDAR) sensors, radar, accelerometers, and/or gyroscopic sensors, etc. Sensor data can also include data collected from one or more sensors not physically proximate to the AV, including sensors disposed on another vehicle, and/or sensor data collected from third-party devices. In some instances, collected sensor data can include data regarding the motion of objects proximate to an AV, such as pedestrians and/or traffic participants. As such, sensor data can include traffic hand signals observed from pedestrians and/or various other traffic participants.

Sensor data collected at block 102 is provided to a gesture classification model (104) configured to identify/classify the recorded hand signals/gestures. Depending on the desired implementation, the sensor data may be provided in different forms. In some approaches, the sensor data may input to gesture classification model 104 as a set of 2D images. By way of example, the sensor data may be converted into a skeletal animation format, e.g., as a series of 2D skeletal animation frames, prior to consumption by classification model 104. In other approaches, the sensor data may include 3D motion data, such as video feeds that include traffic gestures/signals and/or other motions/behaviors observed by the AV.

The process of gesture classification (108) is used to identify motion events perceived by the AV, including traffic hand signals that may be relevant to AV maneuver and/or navigation planning. Notably, the gesture classification process (108) also identifies motions, gestures, and other behaviors that may not necessarily be relevant to AV operations, i.e., that should be ignored. By way of example, detected motion events can include relevant hand signals of specific traffic participants, for example, that indicate upcoming turns (e.g., a right turn 112, or left turn 114) of nearby vehicles, bicyclists, scooterists, and/or skateboarders, etc.

By way of example, signals may be used to recognize the stopping (or slowing) of a vehicle or other traffic participant (e.g., Stopping/Slowing 110), or gestures intended to communicate that a vehicle should proceed 115 along a given route. Additionally, traffic signals/gestures may be used to infer or determine traffic commands issued by an authority (e.g., a human traffic controller), such as an emergency responder, peace officer, construction crew member, and/or traffic director, etc. By way of example, the identified gestures/signals can be used by the AV to determine when to it may be necessary to slow, stop and/or wait, and/or when to re-route a path around an object or area, such as a roadway occluded by a traffic collision or other emergency event.

Many of the detected motions, gestures, and behaviors are likely to be classified as ‘ignore’ or ‘do nothing’ 116. This classification can result from detections of valid traffic hand gestures that are irrelevant or inconsequential to the AV's operation, such as those made by a traffic control officer but that are directed toward a different lane of traffic, or toward non-traffic participants. Additionally, a ‘do nothing’ 116 classification may result from detected motions of pedestrians adjacent to roadways, and/or behaviors of other non-traffic participants that are deemed to be irrelevant to the safety, planning, and/or navigational operations of the perceiving AV.

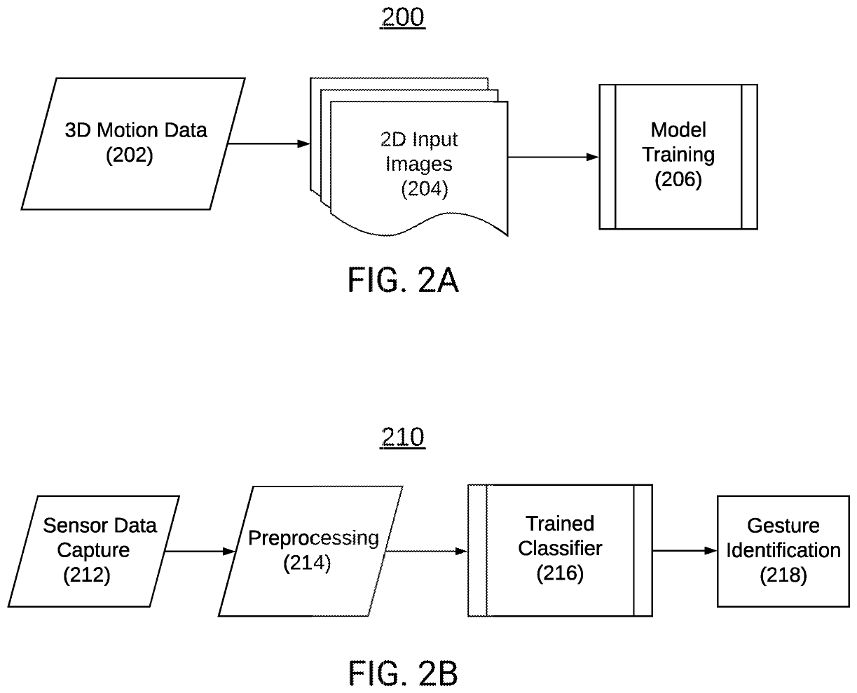

FIG. 2A illustrates a block diagram of an example system 200 for generating or training a gesture classification model, according to some aspects of the disclosed technology. As used herein, gesture/signal classification model can include one or more machine-learning (ML) models, such as a deep-learning neural network. As discussed in further detail below, other ML architectures are contemplated, without departing from the scope of the disclosed technology.

System 200 begins the process of generating/training a gesture classification model at block 202, in which 3D motion data is captured/aggregated. The 3D motion data can include camera motion capture data (e.g., video) and/or skeletal animations of various traffic hand signal being performed. Additionally, the 3D motion data (and resulting skeletal animations) can include non-signal gestures and other behaviors, for example, to provide examples of behaviors/motions that the classification model should classify as irrelevant, i.e., to produce an ‘ignore’ or ‘do-nothing’ state, as discussed above with respect to FIG. 1. Depending on the desired implementation, skeletal animations produced from captured sensor data may include one or more virtual armatures (virtual joints) that indicate an axis around which animated motion is achieved. In this way, 3D motion data can depict various traffic hand signal gestures that are performed, for example, from different observer vantage points (angles). As discussed above, skeletal animation inputs can also represent gestures, motions, or other behaviors that should be ignored by the AV, e.g., that should classified as ‘ignore’ or ‘do nothing.’

In some aspects, the 3D motion data can be pre-processed before it is provided the ML model for training. For example, in block 204, 2D input data, such as one or more 2D animation frames (e.g., skeletal animation frames), and/or images may be extracted from the 3D motion data. In some aspects, preprocessing may include the identification of skeletal structures from still camera feeds (images) or from successive image feeds (video). As such, the resulting 2D input data can include successive frames of skeletal structures, for example, that represent gesture geometries/shapes at discrete times, and/or from specific view angles. In some aspects, preprocessing may also include other image transformations or modifications (e.g., dimension normalization) before the inputs are provided to the ML model. For example, extracted 2D input data can represent skeletal animation images/files that are transformed or rotated at various angles, e.g., to vary a viewpoint of the captured behavior and to improve training data variance.

Finally, in block 206, the 2D input data (204) are provided to an untrained ML model. In some aspects, gesture model training can include a human-assisted labeling process; for example, incorrectly identified traffic hand signals may be corrected using a labeling process that updates the ML model at training block 206. Adjusted or corrected gesture labels can cause the update of one or more weights in one or more layers in the machine learning model (not illustrated).

FIG. 2B illustrates a block diagram of an example system 210 for implementing a traffic hand gesture identification model, for example, on an autonomous vehicle (AV). The implemented model (trained classifier 216) can represent a trained version of an ML traffic signal classification model resulting from model training (block 206), discussed above. The process performed by system 210 begins at block 212 in which AV sensor data is captured using one or more AV sensors. AV sensor data can include video and/or image feeds captured from one or more cameras disposed on or around the AV. For example, while in operation, one or more AV cameras can capture sensor data that includes pedestrians and/or other traffic participants around a vicinity of the AV. The captured sensor data can encode behaviors including gestures/traffic hand signals made by drivers or pedestrians in or around a vicinity of the AV sensors.

At block 214, preprocessing is performed on the captured sensor data. Preprocessing can include image extractions or transformations necessary to prepare the input data (or images) for consumption by trained classifier 216. By way of example, captured 3D motion events may be processed to extract skeletal frames, for example, as successive (2D) frames comprising skeletal representations of a given motion, gesture, or behavior. Once preprocessing 214 is completed, the prepared input data is provided to the trained classifier 216. In some approaches, trained classifier 216 may be implemented on-vehicle. However, remote operations are contemplated. For example, sensor data captured by the AV sensors can be processed and provided to the trained classifier 216 over-the-air, such that, processing to implement the trained classifier 216 is performed at a remote computing node.

Depending on the desired implementation, trained classifier 216 can implement various machine-learning based classification and matching techniques, depending on the desired implementation. For example, machine-learning schemes can utilize one or more of the following, alone or in combination: hidden Markov models, recurrent neural networks, convolutional neural networks (CNNs); deep learning, Bayesian symbolic methods, general adversarial networks (GANs), support vector machines, image registration methods, and/or applicable rule-based systems. Where regression algorithms are used, they may include including but are not limited to: Stochastic Gradient Descent Regressors, and/or a Passive Aggressive Regressor, etc.

Outputs of trained classifier 216 can provide identification of various gestures/traffic hand signals. For example, at block 216, identified gestures/hand signals output by trained classifier 216 can then be used by the AV, for example, to facilitate maneuvering and/or navigation operations.

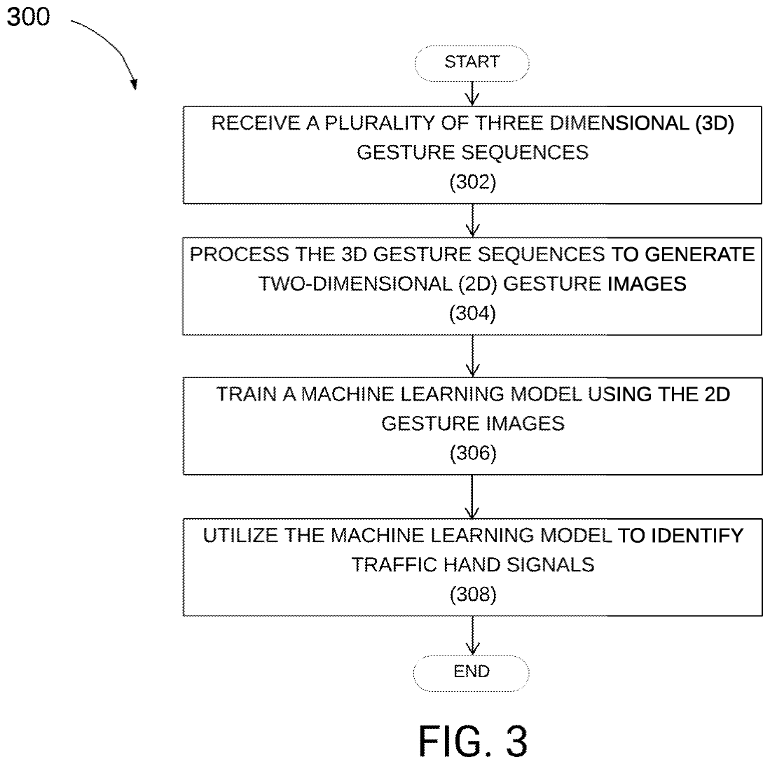

FIG. 3 illustrates a block diagram of a process 300 for performing traffic signal gesture identification. Process 300 begins with step 302 in which a plurality of three-dimensional (3D) gesture sequences are received. The 3D gesture sequences can include video or animation files (data) containing traffic hand signals/gestures from various viewing angles. As discussed above, animation files may include skeletal animations, for example, including one or more virtual armatures and/or an animated meshes that are used to represent the natural movements of a human body, e.g., performing various gestures.

In step 304, the 3D gestures sequences are processed to generate two-dimensional (2D) gesture images. The 2D gesture images can represent snapshots of various gestures as they are being performed, e.g., from different perspectives/angles.

At step 306, the 2D gesture images can be used to train a machine-learning (gesture) classification model. In some aspects, input 2D gesture images can be processed by the ML model and used to predict what type of gesture/traffic hand signal is represented. Classification outputs of the ML model can then be compared to a priori gesture labels, and errors can be used to update/tune the ML model to improve accuracy. For example, a back-propagation scheme may be used to update one or more layer weights in a neural network architecture, thereby improving the accuracy and efficiency of the gesture classification model.

At step 308, the ML model can be deployed to perform gesture classification, for example, in an AV implementation. Identified traffic hand signals/gestures can be used to facilitate AV maneuver and navigation operations, thereby, improving AV situational awareness and safety.

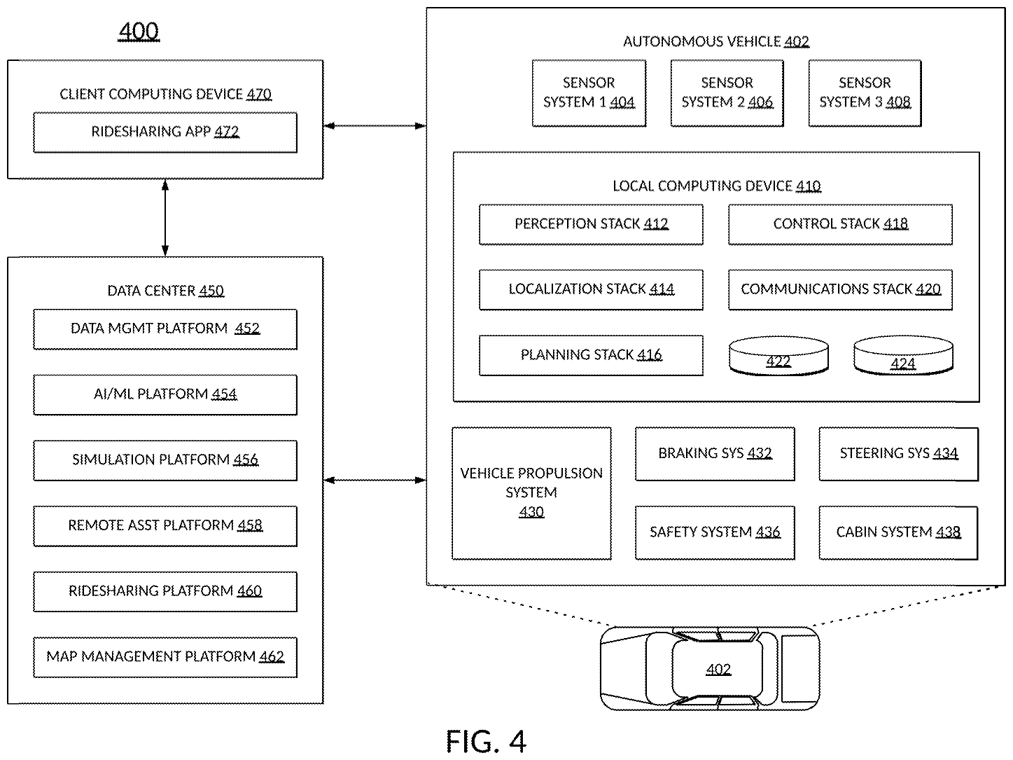

Turning now to FIG. 4 illustrates an example of an AV management system 500. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate about roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate AV 402. For instance, the mechanical systems can include vehicle propulsion system 430, braking system 432, steering system 434, safety system 436, and cabin system 438, among other systems. Vehicle propulsion system 430 can include an electric motor, an internal combustion engine, or both. The braking system 432 can include an engine brake, brake pads, actuators, and/or any other suitable componentry configured to assist in decelerating AV 402. The steering system 434 can include suitable componentry configured to control the direction of movement of the AV 402 during navigation. Safety system 436 can include lights and signal indicators, a parking brake, airbags, and so forth. The cabin system 438 can include cabin temperature control systems, in-cabin entertainment systems, and so forth. In some embodiments, the AV 402 may not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a planning stack 416, a control stack 418, a communications stack 420, an HD geospatial database 422, and an AV operational database 424, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 422, other components of the AV, and other data sources (e.g., the data center 450, the client computing device 470, third-party data sources, etc.). The perception stack 412 can detect and classify objects and determine their current and predicted locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth.

Mapping and localization stack 414 can determine the AV's position and orientation (pose) using different methods from multiple systems (e.g., GPS, IMUs, cameras, LIDAR, RADAR, ultrasonic sensors, the HD geospatial database 422, etc.). For example, in some embodiments, the AV 402 can compare sensor data captured in real-time by the sensor systems 404-408 to data in the HD geospatial database 422 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

The planning stack 416 can determine how to maneuver or operate the AV 402 safely and efficiently in its environment. For example, the planning stack 416 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another. The planning stack 416 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 416 can select from multiple backup plans to carry out. For example, while preparing to change lanes to turn right at an intersection, another vehicle may aggressively cut into the destination lane, making the lane change unsafe. The planning stack 416 could have already determined an alternative plan for such an event, and upon its occurrence, help to direct the AV 402 to go around the block instead of blocking a current lane while waiting for an opening to change lanes.

The control stack 418 can manage the operation of the vehicle propulsion system 430, the braking system 432, the steering system 434, the safety system 436, and the cabin system 438. The control stack 418 can receive sensor signals from the sensor systems 404-408 as well as communicate with other stacks or components of the local computing device 410 or a remote system (e.g., the data center 450) to effectuate operation of the AV 402. For example, the control stack 418 can implement the final path or actions from the multiple paths or actions provided by the planning stack 416. This can involve turning the routes and decisions from the planning stack 416 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 422 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408 and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data as discussed further below with respect to FIG. 2 and elsewhere in the present disclosure.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, a ridesharing platform 460, and map management system platform 462, among other systems.

Data management platform 452 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management system platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management system platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the map management system platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to be picked up or dropped off from the ridesharing application 472 and dispatch the AV 402 for the trip.

Map management system platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, UAVs, satellites, third-party mapping services, and other sources of geospatially referenced data. The raw data can be processed, and map management system platform 462 can render base representations (e.g., tiles (2D), bounding volumes (3D), etc.) of the AV geospatial data to enable users to view, query, label, edit, and otherwise interact with the data. Map management system platform 462 can manage workflows and tasks for operating on the AV geospatial data. Map management system platform 462 can control access to the AV geospatial data, including granting or limiting access to the AV geospatial data based on user-based, role-based, group-based, task-based, and other attribute-based access control mechanisms. Map management system platform 462 can provide version control for the AV geospatial data, such as to track specific changes that (human or machine) map editors have made to the data and to revert changes when necessary. Map management system platform 462 can administer release management of the AV geospatial data, including distributing suitable iterations of the data to different users, computing devices, AVs, and other consumers of HD maps. Map management system platform 462 can provide analytics regarding the AV geospatial data and related data, such as to generate insights relating to the throughput and quality of mapping tasks.

In some embodiments, the map viewing services of map management system platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

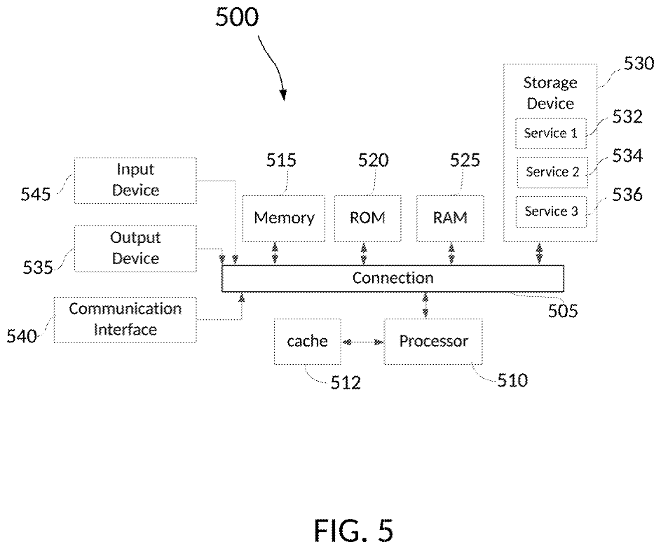

FIG. 5 illustrates an example processor-based system with which some aspects of the subject technology can be implemented. For example, processor-based system 500 can be any computing device making up internal computing system 510, remote computing system 550, a passenger device executing the rideshare app 570, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method for generating a gesture recognition model, comprising:
receiving a plurality of three-dimensional (3D) gesture sequences;
processing each of the 3D gesture sequences to generate two-dimensional (2D) gesture data for each of the 3D gesture sequences; and
training a machine-learning (ML) model using at least a portion of the 2D gesture data for each of the 3D gesture sequences to generate a trained ML model.

2. The computer-implemented method of claim 1, wherein each of the plurality of 3D gesture sequences comprises a traffic hand signal.

3. The computer-implemented method of claim 1, wherein the trained ML model is configured to interpret a traffic hand signal to facilitate an autonomous vehicle (AV) navigation function.

4. The computer-implemented method of claim 1, wherein the trained ML model is configured to interpret a traffic hand signal to facilitate an autonomous vehicle (AV) routing function.

5. The computer-implemented method of claim 1, wherein the trained ML model is configured to determine a relevance of a traffic hand signal.

6. The computer-implemented method of claim 1, wherein the 2D gesture data comprise a skeletal animation.

7. The computer-implemented method of claim 1, wherein the ML model comprises a deep-learning neural network.

8. A system comprising:
one or more processors; and
a computer-readable medium comprising instructions stored therein, which when executed by the processors, cause the processors to perform operations comprising:
receiving a plurality of three-dimensional (3D) gesture sequences;
processing each of the 3D gesture sequences to generate two-dimensional (2D) gesture data for each of the 3D gesture sequences; and
training a machine-learning (ML) model using at least a portion of the 2D gesture data for each of the 3D gesture sequences to generate a trained ML model.

9. The system of claim 8, wherein each of the plurality of 3D gesture sequences comprises a traffic hand signal.

10. The system of claim 8, wherein the trained ML model is configured to interpret a traffic hand signal to facilitate an autonomous vehicle (AV) navigation function.

11. The system of claim 8, wherein the trained ML model is configured to interpret a traffic hand signal to facilitate an autonomous vehicle (AV) routing function.

12. The system of claim 8, wherein the trained ML model is configured to determine a relevance of a traffic hand signal.

13. The system of claim 8, wherein the 2D gesture data comprise a skeletal animation.

14. The system of claim 8, wherein the ML model comprises a deep-learning neural network.

15. A non-transitory computer-readable storage medium comprising instructions stored therein, which when executed by one or more processors, cause the processors to perform operations comprising:
receiving a plurality of three-dimensional (3D) gesture sequences;
processing each of the 3D gesture sequences to generate two-dimensional 2D gesture data for each of the 3D gesture sequences; and
training a machine-learning (ML) model using at least a portion of the 2D gesture data for each of the 3D gesture sequences to generate a trained ML model.

16. The non-transitory computer-readable storage medium of claim 15, wherein each of the plurality of 3D gesture sequences comprises a traffic hand signal.

17. The non-transitory computer-readable storage medium of claim 15, wherein the trained ML model is configured to interpret a traffic hand signal to facilitate an autonomous vehicle (AV) navigation function.

18. The non-transitory computer-readable storage medium of claim 15, wherein the trained ML model is configured to interpret a traffic hand signal to facilitate an autonomous vehicle (AV) routing function.

19. The non-transitory computer-readable storage medium of claim 15, wherein the trained ML model is configured to determine a relevance of a traffic hand signal.

20. The non-transitory computer-readable storage medium of claim 15, wherein the 2D gesture data comprise a skeletal animation.
